(19) United States
(12) Patent Application Publication
(10) Pub. No.: US 2003/0140439 A1
(43) Pub. Date: Jul. 31, 2003

(54) Dry cleansing wipe with improved rinsibility

(75) Inventors: Catherine Durden, Midland Park, NJ (US); Makonnen Payne, Bronx, NY (US)

Correspondence Address: Charles N.J. Ruggiero, Esq., Ohlandt, Greeley, Ruggiero & Perle, L.L.P., One Landmark Square, 10th Floor, Stamford, CT, 06901-2682, US

(73) Assignee: Playtex Products, Inc.

(21) Appl. No.: 10/060,962

(22) Filed: Jan. 30, 2002

(51) Int. Cl. A47L 13/17; B05D 1/02

(52) U.S. Cl. 15/104.93; 427/421

(57) ABSTRACT

A disposable, single use dry cleansing cloth or wipe is provided. The cleansing cloth has a water insoluble substrate and a deposited cleansing solution having a lathering surfactant. The cleansing solution is deposited in an amount such that the cleansing solution rinses out after several re-wettings of said cloth.

### BACKGROUND OF THE INVENTION

1. Field of the Invention

The present invention relates generally to a substantially dry cleansing cloth or wipe that is activated by wetting. More particularly, the present invention relates to a cleansing cloth having a cleansing solution that has improved rinsibility. The present invention further provides that the cleansing cloth has a cleansing solution that rinses from the cloth after a prescribed number of re-wettings.

2. Description of the Prior Art

Traditional methods of bathing require a multi-step process of depositing cleansing solution from a bar or a bottle onto a substrate, and then using the cleansing solution-laden substrate as a vehicle for applying the cleansing solution to the body for washing. Alternately, a cleansing solution may be dispensed into the hand and then applied to the body. These methods of application, cumbersome even for adults, are ill-suited to bathing a baby because such methods require removal of one hand from the baby in order to dispense the cleansing solution onto the hand or cloth or onto the body.

Dry single use cleansing cloths afford the convenience of providing a wash cloth and cleansing solution in one simple step. Single use cleansing cloths eliminate the need for cumbersome bars, bottles or jars of cleansing solution. Thus, single use cloths are ideally suited to use in a baby's bath. While the cleansing wipe of the present invention is described, by way of example, for use in bathing a baby, the wipe may be used for any cleansing need.

Disposable towelettes with imbedded cleansing solution are known. U.S. Pat. No. 5,980,931 to Fowler et al. describes a substantially dry cleansing cloth having a water insoluable substrate with both a cleansing and a conditioning agent deposited thereon.

U.S. Pat. No. 6,132,746 to Hasenoehrl et al. describes a substantially dry, disposable cleansing cloth having a cleansing agent with improved moisturization properties. A conditioning component added to the cleansing agent acts to deposit an amount of conditioner to the skin greater than about 2.5 micrograms/cm².

U.S. Pat. No. 6,190,678 B1 to Hasenoehrl et al. describes a substantially dry, disposable cleansing cloth with an improved method for deposition of conditioning agents onto the skin. The conditioning agent has a lipid hardness value of greater than about 0.02 kg.

While existing disposable cleansing cloths provide bathing convenience, they do not provide for the deposit of an amount of cleansing solution to a water insoluble substrate that is optimized for rinsing out after a prescribed number of re-wet cycles. Accordingly, the prior art does not provide that the substrate can then be used for rinsing the cleansing solution from the skin.

Therefore, a need exists for a cleansing cloth having a cleansing solution with the added convenience of easily rinsing the cleansing solution out of the cloth after several submersions into a bath so that the cloth can then be used as a rinsing cloth.

### SUMMARY OF THE INVENTION

It is an object of the present invention to provide a substantially dry cleansing cloth having a water insoluble substrate and a cleansing solution containing a lathering surfactant deposited thereon.

It is another object of the present invention to provide such a substantially dry cleansing cloth that is disposable and intended for single use.

It is yet another object of the present invention to provide such a substantially dry cleansing cloth on which a cleansing solution is applied in discrete areas.

It is still another object of the present invention to provide a disposable, substantially dry cleansing cloth in which the cleansing solution is rinsed from the cloth after a prescribed number of rinses.

It is a further object of the present invention to provide a disposable, substantially dry cleansing cloth that may be used to rinse the cleansing solution from the body.

It is a still further object of the present invention to provide a disposable, substantially dry cleansing cloth in which the ratio of cleansing solution to fabric substrate is in the range about 1:2.

These and other objects and advantages of the present invention are achieved by a disposable, single use substantially dry cloth onto which a cleansing solution is deposited in discrete areas by striping, dotting or printing onto the substrate surface. The patterned application of the cleansing solution enables a controlled amount of deposition of cleansing solution on each cloth, thereby controlling the amount of lathering action per cloth. The cleansing solution is deposited in an amount that is optimized to rinse out of the cloth after a prescribed number re-wettings. The cloth can then be used to rinse the cleansing solution from the body.

### DETAILED DESCRIPTION OF THE INVENTION

The present invention provides a disposable, single use dry cloth or wipe that has a cleansing solution or composition deposited thereon. The cleansing composition contains a surfactant that provides lathering properties. The approximate composition of the cleansing solution is preferably about 50 percentage by weight or weight percent (wt. %) surfactant and other ingredients such as preservatives and fragrance, and approximately 50 wt. % water. Following a drying process, in which the majority of the water in the cleansing solution is evaporated, the approximate composition of the cleansing solution is about 95 wt. % cleansing solution and other ingredients and approximately 5 wt. % residual water, on a dry basis.

The cleansing solution has one or more surfactants for providing lather. Lathering surfactants that can be used in the present invention may include one or more imidazoline derivatives, fatty sulfosuccinate esters or amides, ethoxylated sorbitan esters, alkylamido alkylamines, betaines, alkoxylated alcohols, phosphourous derivatives, quaternary ammonium compounds, ethoxylated alkyl phenols, alkyl ether sulfates, or any combination thereof. Surfactants are preferably present in an amount about 10 wt. % to about 100 wt. % of the total weight of the cleansing solution or composition on a wet basis. In this application all weight percents are given on a wet basis, unless otherwise indicated. The more preferred range of surfactants is about 30 wt. % to about 80 wt. %, with about 50 wt. % being the most preferred amount, based on the total weight of the cleansing solution on a wet basis. Preferred surfactants that can be used in the present cleansing solution include, but are not limited to, PEG 80 glyceryl cocoate, PEG 30 glyceryl cocoate, cocamidopropyl betaine, decyl glucoside, sodium laureth sulfate, or any combinations thereof.

Water is preferably present in an amount greater than about 0 wt. % to about 90 wt. %. More preferably, water is present in an amount about 50 wt. % based on the total weight of the cleansing solution.

The present solutions or compositions may also have one or more preservatives. The preservatives act to mitigate against unwanted mold or bacteria in the finished product. Preservatives that can be used in the present cleansing solutions include one or more parabens including methylparaben and propyparaben; organic acids and their derivatives including citric acid, sorbic acids, malic acids; idophors; quaternary ammonium compounds; urea derivatives; isothiazolinones; alkyl substituted amino acids; or any combinations thereof. Preferred preservatives include imidazolidinyl urea, methylparaben, propylparaben, or any combinations thereof. Preservatives are preferably present in an amount about 0.05 wt. % to about 5.0 wt. % of the total weight of the cleansing solution. The more preferred range of preservatives is about 0.1 wt. % to about 2.0 wt. %, with 1.0 wt. % being the most preferred amount, based on the total weight of the cleansing solution.

In addition, the cleansing solution preferably has a pH adjuster. One such pH adjuster that can be used in the present cleansing solution is citric acid. The pH adjuster is preferably present in an amount about 0.01 wt. % to about 1.0 wt. % based on the total weight of the cleansing solution. More preferably, the pH adjuster is present in an amount about 0.2 wt. % based on the total weight of the cleansing solution.

The cleansing solution preferably has a fragrance. The fragrance is preferably present in an amount about 0.05 wt. % to about 2.5 wt. % based on the total weight of the cleansing solution. More preferably, the fragrance is present in an amount about 0.6 wt. % based on the total weight of the cleansing solution.

The cleansing solution may have a skin conditioner. The skin conditioner acts to nourish and soothe the skin. Skin conditioners that can be used in the present cleansing solutions include, but are not limited to, one or more lanolins, polyols including glycerin and sorbitol, botanical derivatives including aloe, vitamins including vitamin E, silicones including dimethicone, quaternary surfactants, esters, mineral oils, petrolatums, C7-C40 branched chain hydrocarbons, C1-C30 alcohol esters of C1-C30 carboxylic acids, C1-C30 alcohol esters of C2-C30 dicarboxylic acids, monoglycerides of C1-C30 carboxylic acids, diglycerides of C1-C30 carboxylic acids, triglycerides of C1-C30 carboxylic acids, ethylene glycol monoesters of C1-C30 carboxylic acids, ethylene glycol diesters of C1-C30 carboxylic acids, propylene glycol monoesters of C1-C30 carboxylic acids, propylene glycol diesters of C1-C30 carboxylic acids, C1-C30 carboxylic acid monoesters and/or polyesters of sugars, polydialkylsiloxanes, polydiarylsiloxanes, polyalkarylsiloxanes, cylcomethicones having 3 to 9 silicon atoms, vegetable oils, hydrogenated vegetable oils, polypropylene glycol C4-C20 alkyl ethers, di C8-C30 alkyl ethers, or any combinations thereof.

The cleansing solution may also have an aromatherapy component. The aromatherapy component acts to provide a natural and pleasing scent that can help to relax and calm or promote sleep or provide other benefits well known in the art of aromatherapy. Aromatherapy components may include, but are not limited to, chamomile and lavender.

The following is an example of the cleansing solution of the preferred embodiment of the present invention.

### EXAMPLE 1

| Ingredient | w/w % | w/w % (active) |
|---|---|---|
| Water | 0.0 | 49.96 |
| Surfactant | | |
| PEG 80 Glyceryl Cocoate (and) | 34.079 | 27.20 |
| PEG 30 Clyceryl Cocoate | | |
| Cocamidopropyl Betaine (30%) | 22.164 | 6.65 |
| Decyl Glucoside (50%) | 14.337 | 7.17 |
| Sodium Laureth Sulfate (26%) | 27.570 | 7.17 |
| Fragrance | 0.662 | 0.66 |
| Preservative | | |
| Imidazolidinyl Urea and | 0.560 | 0.56 |
| Propylene Glycol (solvent) | | |
| Methylparaben | 0.265 | 0.26 |
| Propylparaben | 0.176 | 0.18 |
| PH Adjuster | | |
| Citric Acid | 0.187 | 0.19 |

The cleansing solution is deposited on the substrate cloth or wipe in an amount such that the cleansing solution rinses out of the cloth after several re-wettings. The substrate is re-wet when it is substantially moistened, covered, or saturated with water or other liquid. In the preferred embodiment of the present invention, the cleansing solution rinses out of the cloth after 3 to 5 re-wettings. Once the cleansing solution is rinsed from the cloth, the cloth may then be used to rinse the cleansing solution from the body or substrate upon which the cloth or wipe has been used.

The cleansing solution is applied to the substrate in an amount that is optimized to rinse from the substrate after 3 to 5 re-wettings. The cleansing solution is deposited on each sheet of cloth in an amount about 1.0 grams (g) to about 4.0 g and in an amount about 0.5 g to about 2.0 g per sheet on a dry basis. In the preferred embodiment, approximately 1.0 g to approximately 1.5 g of dry cleansing solution is applied to one 6.5″×7.0″ washcloth, which weighs approximately 3.1 g to approximately 3.8 g. The approximate ratio of cleansing solution to fabric in a wipe or cloth of the present invention is in the range about 1:2 in a dry state.

The cleaning solution is deposited on the substrate by one or a combination of methods to produce discrete, patterned areas. The patterned application of the cleansing solution enables a controlled amount of deposition of cleansing solution on each cloth, thereby controlling the amount of lathering action per cloth. The application in discrete areas may be accomplished by striping, dotting or printing the cleansing solution onto the substrate surface.

Striping, dotting or printing the cleansing solution onto the substrate may be accomplished by spraying the cleansing solution onto the substrate to coat the substrate. During the spraying process, a roll of substrate is unwound beneath a series of spraying heads. The spraying heads are adjusted to deliver the specified amount of cleansing solution onto the substrate. The sprayed substrate is then passed through a drying oven to drive off residual water, and is then either re-wound or cut, folded and placed into suitable packaging.

Alternately, the cleansing solution may be striped, dotting or printed onto the substrate by slot coating. In the slot coating process, the cleansing solution is forced through a slot onto the surface of the substrate, thereby producing a substrate patterned with cleansing solution. During the slot coating process, the roll of substrate is unwound and passed before or beneath a metal slot through which a specified amount of cleaning solution is delivered. Following coating, the substrate then passes through a drying oven to drive off residual water, and is then either re-wound into a roll or cut, folded and placed into suitable packaging.

The cleansing solution may also be applied by a knife over blade process. In this process, the cleansing solution is flooded onto the substrate surface. The excess cleansing solution is then removed using a blade. After coating, the substrate passes through a drying oven to drive off residual water, and is then either re-wound or cut, folded and placed into suitable packaging.

The cleansing cloth substrate is formed of a nonwoven fabric that is uniformly free of gaps. Nonwoven fabric is made of fibers that are formed into a sheet rather than woven into a fabric. The nonwoven fabric substrate can be formed of a single layer or multiple layers of fabric. In the preferred embodiment, the nonwoven substrate is a single layer of needlepunched fabric with a basis weight of about 100 grams per square meter that has about 25% to about 35% lyocell fiber by weight, and about 65% to about 75% polyester fiber by weight. The cross directional tensile strength of the dry nonwoven fabric is a minimum of 2000 g/in. The needlepunched fabric may also be constructed of varying combinations (totaling 100%) of lyocell, polyester, rayon, or polypropylene to optimize the strength, thickness and feel of the fabric. In an alternate embodiment, the substrate may be a single layer of spun laced fabric containing about 50% rayon and about 50% polyester by weight. Methods of making nonwoven substrates are well known in the art and include air-laying, water-laying, meltblowing, conforming, spun lacing or carding a layer of natural and synthetic fabric that is then subjected to bonding.

The present invention has been described with particular reference to the preferred embodiments. It should be understood that the foregoing descriptions and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. A disposable, single use dry cloth having a cleanser deposited thereon comprising:
a water insoluble substrate; and
a cleansing solution having a lathering surfactant,
wherein said cleansing solution is deposited in an amount such that it rinses out after several re-wettings of said cloth.

2. The cloth of claim 1, wherein said cleansing solution is deposited in a pattern.

3. The cloth of claim 2, wherein said pattern is striped.

4. The cloth of claim 2, wherein said pattern is dotted.

5. The cloth of claim 1, wherein the ratio of said cleansing solution to said substrate is in the range about 1:2.

6. The cloth of claim 1, wherein the cloth can be used to rinse said cleansing solution from a body.

7. The cloth of claim 1, wherein said cleansing solution is applied to said substrate by spraying.

8. The cloth of claim 1, wherein said cleansing solution is applied to said substrate by slot coating.

9. The cloth of claim 1, wherein said cleansing solution is applied to said substrate by a knife over blade process.

10. The cloth of claim 1, wherein said cleansing solution is deposited on said substrate in an amount about 1.0 g to about 4.0 g on a wet basis.

11. The cloth of claim 1, wherein said cleansing solution is deposited on said substrate in an amount about 0.5 g to about 2.0 g of on a dry basis.

12. The cloth of claim 1, wherein said substrate is a needlepunched fabric.

13. The cloth of claim 12, wherein said needlepunched fabric has about 35% lyocell and about 65% polyester.

14. The cloth of claim 1, wherein said cleansing solution further comprises water and at least one lathering surfactant.

15. The cloth of claim 1, wherein said cleansing solution further comprises water and at least one preservative.

16. The cloth of claim 14, wherein said cleansing solution further comprises a fragrance.

17. The cloth of claim 14, wherein said cleansing solution further comprises a pH adjuster.

18. A disposable, single use dry cloth with a cleanser deposited thereon comprising:
a water insoluble substrate; and
a cleansing solution having a lathering surfactant, said cleansing solution being deposited in a pattern on said substrate;
wherein said cleansing solution is deposited in an amount such that it rinses out after several re-wettings of said cloth.

19. The cloth of claim 18, wherein said cleansing solution further comprises water and at least one preservative.

20. A method of manufacturing a single use dry cloth with a cleanser deposited thereon comprising:
providing a water insoluble substrate; and
depositing a cleansing solution having a lathering surfactant to said substrate,
wherein said cleansing solution is deposited in an amount such that it rinses out after several re-wettings of said cloth, and
wherein the ratio of said cleansing solution to said substrate is in the range about 1:2.

21. The method of claim 20, wherein said cleansing solution is deposited in a pattern.

22. The method of claim 20, wherein said cleansing solution is applied by spraying.
